(19) United States
(12) Patent Application Publication
(10) Pub. No.: US 2008/0261067 A1
(43) Pub. Date: Oct. 23, 2008

(54) Metallic Composite Material

(76) Inventors: Yuki Okamoto, Aichi-ken (JP); Kyoichi Kinoshita, Aichi-ken (JP); Motoharu Tanizawa, Aichi-ken (JP); Manabu Sugiura, Aichi-ken (JP); Fuminobu Enokijima, Aichi-ken (JP)

Correspondence Address: MORGAN & FINNEGAN, L.L.P., 3 WORLD FINANCIAL CENTER, NEW YORK, NY, 10281-2101, US

(21) Appl. No.: 11/792,117

(22) PCT Filed: Nov. 11, 2005
(86) PCT No.: PCT/JP2005/021184

§ 371 Date: Apr. 7, 2008

(30) Foreign Application Priority Data
Dec. 2, 2004 (JP) 2004-350316

(51) Int. Cl. B32B 15/02; B22F 7/02

(52) U.S. Cl. 428/548

(57) ABSTRACT

A metallic composite material according to the present invention is a metallic composite material, which comprises: a composited portion having a sintered body 1 being completed by sintering a metallic powder of a first metal, and a second metal 2′ infiltrating into the pores of the superficial-layer portion of the sintered body 1 at least; and a parent-material portion having the second metal 2 covering the composited portion, and is characterized in that the sintered body 1 is completed by sintering the metallic powder together with a melt-disappearing material, which possesses a melting point being the sintering temperature of the metallic powder or less, or a burn-disappearing material, which burns to disappear at the sintering temperature or less; and the metallic composite material is equipped with a fitting portion at the interface between the composited portion and the parent-material portion, fitting portion which is formed by infiltrating the second metal 2′ into the pores and additionally getting the second metal 2′ into parts 3 where the melt-disappearing material has been melted to disappear or the burn-disappearing material has been burned to disappear. By means of this novel construction, it is possible to suppress the occurrence of cracks and peeling, which occurs in metallic composite material.

In the present invention, the melt-disappearing material can preferably include an alloying component element, which forms an alloy with a major component element of the metallic powder. When major component element is iron and the alloying component element is copper, the strength of the fitting portion improves.

### TECHNICAL FIELD

The present invention relates to a metallic composite material, which comprises metals of different types.

### BACKGROUND ART

Since composite materials, which are made by combining different species of constituent raw materials, turn into materials, which have various characteristics being not achievable with conventional materials, by means of changing the types or volumetric proportions of constituent raw materials, they are extremely useful in many fields of industrial materials.

As one of metal-based composite materials whose parent materials are metals, a metallic composite material is available in which a metal is cast around a sintered body so that the metal is disposed on the superficial portion of the sintered body. In metallic composite materials possessing such a construction, cracks might occur at the interface between both of them (in the surface of sintered body) in environments with violent temperature changes, such as upon cooling after heat treating the composite materials, for instance. This occurrence of cracks results from the thermal expansion difference between sintered body and metal. In particular, although metallic composite materials, which comprise an iron-based sintered body and a light metal such as an aluminum alloy, have been used in various fields, they have a problem that, because the thermal expansion difference between iron-based metal and light metal is great, cracks are likely occur in the surface involving the sintered body.

Hence, in Japanese Unexamined Patent Publication (KOKAI) Gazette No. 8-229,663, a metallic composite material is disclosed, the metallic composite material, which comprises: a composited portion made of an iron-based sintered body and an aluminum alloy infiltrating into the pore sections thereof and being solidified therein; and a parent-material portion made of an aluminum alloy, wherein the thermal expansion difference is made 5×10⁻⁶/K or less at the interface between the composited portion and the parent-material portion. Specifically, of the iron-based sintered body, the sintered body, which is positioned on the side of the interface between the parent-material portion and the composited portion, is formed of a powder of stainless steel; and the thermal expansion difference is made 5×10⁻⁶/K or less at the interface, thereby securing an anti-cracking property.

Moreover, in Japanese Unexamined Patent Publication (KOKAI) Gazette No. 9-206,915, a component part for pulverizer is disclosed, component part in which a hard alloy made of tungsten carbide and a binding material is cast wrapped with a cast-iron material having the same component as that of the binding material. The surface of the hard alloy is coated with the cast-iron material having the same component as that of the binding material, and thereby the adhesiveness between the hard alloy and the cast-iron material, which is cast around it, is improved.

However, since these metallic composite materials are such that, since other raw-material powders have been necessary or the number of processing steps has increased and are therefore accompanied by the enlargement of working times and the increment of costs, they cannot be a simple and easy technique.

### DISCLOSURE OF THE INVENTION

The present invention, in view of the aforementioned problematic points, is such that it is an object to provide a metallic composite material, which comprises a novel construction and can suppress the occurrence of cracks and peeling.

A metallic composite material according to the present invention is a metallic composite material, which comprises: a composited portion comprising a sintered body being completed by sintering a metallic powder of a first metal, and a second metal infiltrating into the pores of the superficial-layer portion of the sintered body at least; and a parent-material portion comprising the second metal covering the composited portion,

the metallic composite material being characterized in that: said sintered body is completed by sintering said metallic powder together with a melt-disappearing material, which possesses a melting point being the sintering temperature of the metallic powder or less, or a burn-disappearing material, which burns to disappear at the sintering temperature or less; and the metallic composite material is equipped with a fitting portion at the interface between said composited portion and said parent-material portion, fitting portion which is formed by infiltrating said second metal into said pores and additionally getting said second metal into parts where the melt-disappearing material has been melted to disappear or the burn-disappearing material has been burned to disappear.

Since the sintered body is one which is completed by sintering the metallic powder, and the melt-disappearing material, which possesses a melting point being the sintering temperature of the metallic powder or less, or the burn-disappearing material, which burns to disappear at the sintering temperature or less, all together, the pores open satisfactorily in parts where the melt-disappearing material has been melted to disappear or the burn-disappearing material has been burned to disappear, that is, in the sintered-body-side (composited-portion-side) surface of the fitting portion. Accordingly, the metallic composite material according to the present invention is good in terms of the infiltratability during the production; and moreover is also good in terms of the adhesion between the composited portion and the parent-material portion at the fitting portion.

And, by means of the fact that it possesses the fitting portion at the interface between the composited portion and the parent-material portion, it is possible to reduce cracks, which result from the thermal expansion difference between the composited portion and the parent-material portion to occur. On this occasion, it is desirable that said fitting portion can be constituted of a dented portion, which is formed in said sintered body when said melt-disappearing material has been melted to disappear or said burn-disappearing material has been burned to disappear, and a protruded portion, which is formed on the side of the parent-material portion when said second metal has got into the dented portion.

Moreover, the designating terms such as “first” and “second” are designating terms for distinguishing between the members, and the like, for convenience. Therefore, as far as the first metal and the second metal are metals with different compositions, it is satisfactory.

In the present invention, said melt-disappearing material can preferably include an alloying component element, which forms an alloy with a major component element of said metallic powder. On this occasion, the major component element can preferably be iron, and the alloying component element can preferably be copper. Since copper, the component of the melt-disappearing material, is solved into iron by means of sintering, the strength of the fitting portion improves.

To put it differently, the metallic composite material according to the present invention is such that it is possible to grasp it as a metallic composite material being a metallic composite material, which comprises: a composited portion comprising a sintered body being completed by sintering a metallic powder of a first metal, and a second metal infiltrating into the pores of the superficial-layer portion of the sintered body at least; and a parent-material portion comprising the second metal covering the composited portion,

the metallic composite material being characterized in that: it further possesses a fitting portion at the interface between said composited portion and said parent-material portion; and an alloy, which comprises a major component element of said metallic powder and an alloying component element forming the alloy with the major component element, is formed at the fitting portion on the side of the composited portion.

As for the fitting portion, the sintered body can preferably be completed by sintering said metallic powder together with a melt-disappearing material, which possesses a melting point being the sintering temperature of the metallic powder or less, or a burn-disappearing material, which burns to disappear at the sintering temperature or less; and the fitting portion can preferably be formed by infiltrating said second metal into said pores and additionally getting said second metal into parts where said melt-disappearing material has been melted to disappear or said burn-disappearing material has been burned to disappear.

Moreover, it is preferable that said first metal can be an iron-based metal, which includes iron; and that said second metal can be a light metal. By using a light metal, it turns into a metallic composite material, which is lightweight and is of high strength. On this occasion, it is preferable that said light metal can be an aluminum alloy.

### BRIEF DESCRIPTION OF THE DRAWINGS

With reference to the following detailed description and the accompanying drawings, the present invention can be understood more profoundly. Hereinafter, the brief description of the drawings is done.

FIG. 1 is a cross-sectional view for schematically showing an example of a metallic composite material according the present invention.

FIG. 2 is an explanatory diagram for explaining a production process for a sintered body, which is used for a metallic composite material according to an embodiment, and is an axial cross-sectional view of a forming mold and a green compact.

FIG. 3 is a cross-sectional view of a sintered body, which is used for a metallic composite material according to an embodiment.

FIG. 4 is a plan view (upper diagram) of a sintered body, which is used for a metallic composite material according to an embodiment, and a side view (lower diagram) thereof.

FIG. 5 is an axial cross-sectional view of a metallic composite material according to an embodiment.

FIG. 6A is a photograph, a substitute for a diagram for showing the result of a color checking inspection on a metallic composite material according to an embodiment, and is a photograph in which the lower end surface (being equivalent to the position designated with “A1” in FIG. 5) of the metallic composite material was photographed. FIG. 6B is a photograph, a substitute for a diagram for showing the result of a color checking inspection on a metallic composite material according to an embodiment, and is a photograph in which the inner surface (being equivalent to the position designated with “B1” in FIG. 5) of the metallic composite material was photographed.

FIG. 7A is a photograph, a substitute for a diagram for showing the result of a color checking inspection on a metallic composite material according to a comparative example, and is a photograph in which the lower end surface of the metallic composite material was photographed. FIG. 7B is a photograph, a substitute for a diagram for showing the result of a color checking inspection on a metallic composite material according to a comparative example, and is a photograph in which the inner surface of the metallic composite material was photographed.

FIG. 8 is a photomicrograph of a metallic composite material according to an embodiment, and is a photomicrograph of the cross section at the position designated with “C1” in FIG. 5.

FIG. 9 is a photomicrograph of a metallic composite material according to an embodiment, and is a photomicrograph of the cross section at the position designated with “D1” in FIG. 5.

FIG. 10 is a graph for showing the Vickers hardness of the respective portions of a metallic composite material according to an embodiment.

### BEST MODE FOR CARRYING OUT THE INVENTION

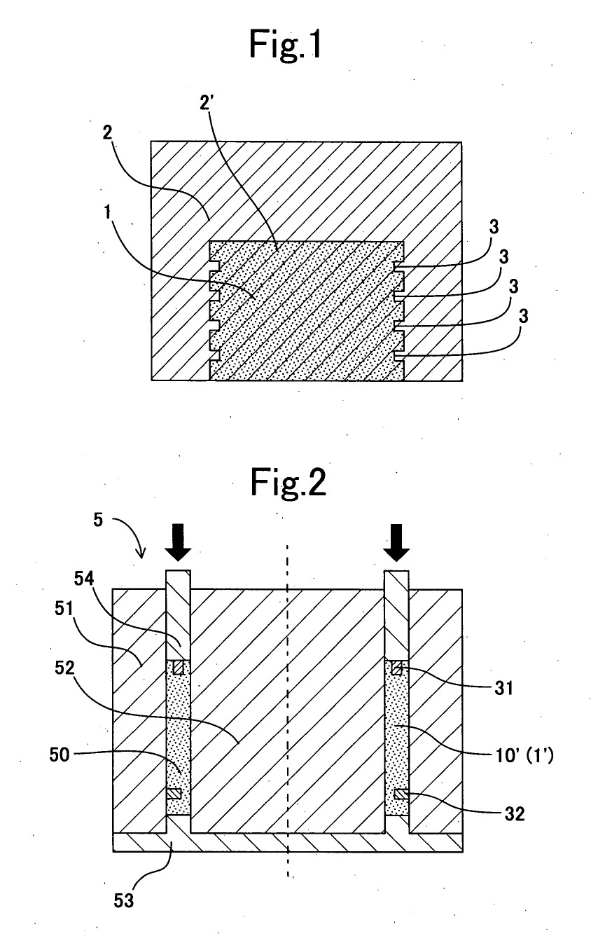

In order to explain and describe the present invention in more detail, hereinafter, the best mode for carrying out a metallic composite material according to the present invention will be explained using FIG. 1.

A metallic composite material according to the present invention comprises a composited portion comprising a sintered body being completed by sintering a metallic powder of a first metal, and a second metal infiltrating into the pores of the superficial-layer portion of the sintered body at least; and a parent-material portion comprising the second metal covering a part of the composited portion at least.

Specifically, in the metallic composite material according to the present invention, it is satisfactory that the second metal can be disposed in the superficial-layer portion of the sintered body at least; and it is acceptable that, depending on the parts and configurations in which the metallic composite material is employed, the disposition between the composited portion, which comprises the sintered body and the second metal, and the parent-material portion, which comprises the second metal, can be selected appropriately. For example, in addition to being a laminated body in which the composited portion and the parent-material portion are laminated to each other in such a state that the second metal infiltrates into one of the surfaces of the sintered body with a flat-plate shape to cover it, it is acceptable that the composited portion can be positioned so as to be surrounded with the parent-material portion by means of cast wrapping the second metal 2 around the sintered body 1 with a rectangular-parallelepiped configuration other than the bottom surface, for instance, as illustrated in FIG. 1.

Moreover, in the composited portion, the second metal is present in the pores of the superficial-layer portion thereof (the second metal 2′ in FIG. 1, for instance) at least. Note that the second metal can be infiltrated into a part or the entirety of the pores, which the sintered body possesses, and can be solidified therein. Therefore, the metallic composite material according to the present invention can desirably be produced by cast wrapping the second metal around the sintered body by means of casting. Especially, casting methods, such as a squeeze casting method and a liquid metal infiltration method, are suitable. In these casting methods, since it is possible to infiltrate the second metal not only into the superficial-layer portion of the sintered body but also into the inside thereof because casting is done while carrying out pressurizing, a metallic composite material, which is close to being nonporous, is obtainable.

The sintered body is such that, as far as it has a part such as the dented portion which constitutes a later-described fitting portion, there is not any limitation on the configuration and material quality thereof. It is acceptable that they can be selected appropriately depending on the configurations of the metallic composite material and the parts in which the metallic composite material is employed. The metallic powder can be powders which have been used for sintered bodies conventionally, and configurations, whose particle diameter is 1-250 μm and which are a spherical shape or close to a spherical shape, can be used. These powders can be obtained by means of various atomizing methods and pulverizing methods, and the like, for instance. And, although there is not any limitation on the type of the first metal in particular, iron-based metallic powders, which include iron (Fe), are preferable as the metallic powder of the first metal; for example, it is possible to use various alloy steel powders (SKD-based ones (JIS G4404), SKH-based ones (JIS G4403), and so forth), cast iron powders, carbon steel powders, and so on.

Further, not limited to the cases of being comprised of the aforementioned metallic powders alone, it can even be a mixture powder, which includes a lubricant or an additive, and the like. Moreover, it can be various powders of alloying elements other than metals, such as carbon (C) and boron (B), or powders containing them; further, it can even include various compound powders like ceramic powders.

Moreover, the sintered body can be those which have such an extent of porosity (the volumetric proportion [%] of the pores that account for the volume of the sintered body: hereinafter, being labeled “Vp”) and pore diameter that the second metal can infiltrate into the pores thereof. Note, however, that it is not preferable to use a sintered body which has high porosity or coarse pores, because the strength of the sintered body lowers; moreover because the sintered body might be damaged depending on the method of infiltrating the second metal into the sintered body. Therefore, the sintered body can preferably be such that the volumetric fraction thereof (“Vf”=100−“Vp” [%]) is 45% or more, and can further preferably be such that it is 55-85%.

Although the second metal is such that there is not any limitation on the type thereof in particular, the present invention demonstrates good effects under the condition of combining metals so that the first metal and the second metal exhibit a great thermal expansion difference. Moreover, the second metal, as described above, is such that a part thereof infiltrates into the pores of the sintered body and is solidifies therein, there is not any limitation on the type of the second metal as far as the sintered body does not melt or degrade upon infiltrating a molten metal of the second metal into the sintered body. For example, when it is a metal whose melting point is lower than that of the first metal constituting the sintered body, it is possible to readily produce the metallic composite material. Specifically, when the first metal is an iron-based metal, the second metal can preferably be an aluminum alloy or a magnesium alloy; when the first metal is a copper-based metal, the second metal can preferably be an aluminum alloy or a magnesium alloy.

Moreover, the metallic composite material according to the present invention can preferably be such that the first metal is an iron-based metal, which includes iron (Fe), and the second metal is a light metal. By means of combining an iron-based metal, which is of high strength, and a light metal, the metallic composite member, which is lightweight and is of high strength, is obtainable. As for the light metal, it can preferably be aluminum-based metals, such as pure aluminum (Al) and aluminum alloys including Mg, Cu, Zn, Si, Mn, and the like; and it can preferably be magnesium-based metals, such as pure magnesium (Mg) and magnesium alloys including Zn, Al, Zr, Mn, Th, rare-earth elements, and so forth.

And, the metallic composite material according to the present invention is equipped with the fitting portion at the interface between the composited portion and the parent-material portion. For example, as illustrated in FIG. 1, the fitting portion can desirably be constituted of dented portions 3, which are formed in a sintered body 1, and protruded portions, which are formed on the parent-material portion side when a second metal 2 has got into the dented portions 3. As described above, the second metal exists in the superficial-layer portion of the sintered body 1 at least. Therefore, it is the protruded portions of the second metal 2 as the parent-material portion that fit with the dented portions 3 of the sintered body 1. When the metallic composite material is produced by the above-described casting methods using a sintered body having dented portions like those aforementioned, the protruded portions are formed of itself by means of burying the internal spaces of the dented portions with a molten metal of the second metal when the second metal has infiltrated into the pores and additionally the second metal has got into parts where the burn-disappearing member has been burned to disappear or the melt-disappearing member has been melted to disappear. Note that it is satisfactory that the protruded portions and dented portions 3 are such that, not limited to the squared shapes like those in FIG. 1, their cross-sectional configurations can be triangles; or can be polygons or key patterns; and moreover their configurations can be solid cylindrical shapes or semi-sphere shapes, which can fit between the sintered body 1 and second metal 2′, the composited portion, and the second metal 2, the parent-material portion.

And, by means of forming a dented portion (fitting portion) at locations in the metallic composite material where cracks are likely to occur, that is, in the superficial-layer portion of the sintered body, it is possible to reduce cracks, which occur in metallic composite materials resulting from the thermal expansion difference between the composited portion and the parent-material portion, during services in environments where the heat treatments or temperature changes are fierce. For example, when the sintered body has a hollow cylindrical configuration, it is acceptable to form a dented portion at one or more locations of either one of an outer peripheral portion, inner peripheral portion, end portion and another end portion thereof. Moreover, of the interface between the composited portion and the parent-material portion, it is effective when it is formed in a plane, which involves a section being exposed linearly in the surface of the metallic composite material. For example, the metallic composite material in FIG. 1 is such that the interface is exposed on the lower side of the diagram. This exposed interface can be observed linearly. By forming the dented portions 3 or protruded portions, the fitting portion, along a plane, which involves this exposed section, cracks become unlikely to occur. Moreover, there is no limitation on the quantity of dented portion, and it is acceptable to form it in a plurality of pieces as shown in FIG. 1. By means of suitably selecting the forming position and forming quantity of dented portion, it is possible to effectively reduce the occurrence of cracks. Moreover, the dented portions 3 or protruded portions, the fitting portion, are not limited to such a construction that they continue as a grooved shape. It is satisfactory that a fitting portion can be disposed discontinuously to such an extent that cracks do not occur; or it is acceptable that it can be disposed partially.

Moreover, since the superficial area of the sintered body is increased by means of forming dented portions, the thermal conductivity improves. Here, in general, it is said that, in the interface between different materials, heat is likely to transmit in the direction parallel to the interface. Namely, when forming a dented portion, which possesses a perpendicular plane with respect to the interface, the thermal conductivity improves furthermore. Therefore, a dented portion can preferably be formed as a cross-sectionally letter-U shape.

The fitting portion on the side of the composited portion, such as the dented portions, is a part where the sintered body is formed by sintering the metallic powder together with a melt-disappearing material, which possesses a melting point being the sintering temperature of the metallic powder or less, or a burn-disappearing material, which burns to disappear at the sintering temperature or less; and where the melt-disappearing material has been melted to disappear or the burn-disappearing material has been burned to disappear. As described above, the fitting portion is formed by getting the second metal into that part upon producing the metallic composite material by carrying out casting. The melt-disappearing material or burn-disappearing material is not limited in particular as far as it comprises a material which melts to disappear or burns to disappear at the sintering temperature of the metallic powder or less. Therefore, in addition to metals and resins, it can be paper or wood, and so the material quality thereof does not matter.

The melting point of the melt-disappearing material can preferably be closer to the sintering temperature. When the gap between the sintering temperature of the metallic powder and the melting point of the melt-disappearing material is too great, there is a fear that the melt-disappearing material might vaporize to contaminate furnace casings during the sintering step. For example, when the metallic powder is an iron-based metallic powder, the melt-disappearing material can preferably be copper (Cu). Specifically, when letting the sintering temperature of the iron-based metallic powder be 1,100° C., it is acceptable to make copper (melting point: 1,083° C.) a material for the melt-disappearing material.

Moreover, a material quality of the melt-disappearing material can suitably be those including an alloying component element, which forms an alloy with a major component element of the metallic powder (first metal). By means of appropriate combinations, it is possible to intend the improvement of the sintered body's strength, thermal conductivity, sliding property, and the like. For example, when a major component element of the metallic powder is iron (Fe), if the alloying component element is copper (Cu), Cu is solved into Fe so that the sintered body's strength and thermal conductivity can be improved. Other than this, it is possible to think of the following various combinations of the major component element and alloying component element: when making Fe the major component element, in addition to aforementioned Cu, it is possible to think of carbon (C), chromium (Cr), molybdenum (Mo), nickel (Ni), vanadium (V), and so forth, as the alloying component element.

Moreover, since the configuration of the melt-disappearing material and burn-disappearing material becomes the same configuration as that of the internal space of a dented portion in the sintered body which is obtainable after sintering, it can suitably be selected depending on the configuration of a dented portion; and accordingly it is possible to use plate-shaped, rod-shaped or linear melt-disappearing materials. Specifically, when the sintered body has a hollow cylindrical configuration, it is possible to form a ring-shaped groove in the sintered body by allocating an annular melt-disappearing material so as to be coaxial therewith upon forming the metallic powder.

By the way, the melt-disappearing material is diffused into the surface of the metallic powder, which has been sintered, via the pores, which exist around the melt-disappearing material, by means of sintering. Moreover, depending on a material quality of the melt-disappearing material, there might be the case that it has disappeared. That is, the melt-disappearing material, after it has melted, hardly closes the pores again when it has solidified, and the like, and accordingly the pores open in the surfaces of parts (dented portions) where it has melted to disappear. As a result thereof, in the metallic composite material according to the present invention, since a molten metal of the second metal is likely to infiltrate thereinto through the dented portions as well; moreover, since the second metal, which exists in the pores opening in the surfaces, and the second metal of the protruded portions are disposed one after another successively to be integral, the adhesiveness between the protruded portions on the side of the parent-material portion and the dented portions on the side of the composited portion improves.

Note that it is general that a dented portion of the sintered body is formed by sintering one which is made by molding using a mold having a protruded portion, which corresponds to the dented portion, or by cutting, and the like, the sintered body. However, depending on the configuration and forming position of a dented portion, there might be cases where the construction of the mold gets complicated or the production thereof is difficult. Moreover, when forming a dented portion by cutting, the pores, which open in the surfaces of the dented portion, are likely to be clogged by means of friction, and so forth. Such a sintered body is not preferable, because it is less likely to infiltrate a molten metal into the pores and is poor in terms of the adhesiveness.

Upon producing the aforementioned sintered body, the metallic powder is molded and is then sintered together with a melt-disappearing material or a burn-disappearing material. For example, using a general forming mold, the metallic powder is filled within a cavity of the forming mold; and additionally a melt-disappearing material or a burn-disappearing material is placed so as to bring it into contact with an inner surface of the cavity or the end surface of a punch; and then a green compact is formed by pressurizing. By sintering the obtained green compact, a sintered body, which has a dented portion formed in the superficial portion when the melt-disappearing material has melted to disappear or the burn-disappearing material has burned to disappear, is obtainable.

As aforementioned, for the formation of dented portion, it is possible to use existing facilities (forming molds). Moreover, a dented portion is formed simultaneously with sintering a green compact. Accordingly, without requiring special production steps, it is possible to readily form a dented portion.

The metallic composite material according to the present invention, in compliance with the types of the first metal and second metal, can be used for component parts for various apparatuses. Especially, the metallic composite material, which comprises the sintered body made of an iron-based member, and a light metal, can be suitably used for the front housing or cylinder block, and the like, of compressors. Above all, it is effective to allocate the sintered body at parts, which are likely to be subjected to high pressures.

So far, the embodiment modes of the metallic composite material according to the present invention have been explained, however, the metallic composite material according to the present invention is not limited to the aforementioned embodiment modes, and can be conducted in various modes to which modifications, improvements, and the like, which one of ordinary skill in the art can carry out, are performed, within a range not departing from the scope of the present invention.

Based on the aforementioned embodiment modes, metallic composite materials were prepared. Hereinafter, examples of the metallic composite material according to the present invention will be explained using FIG. 2-FIG. 10.

[Manufacture of Sintered Body Having Dented Portions]

FIG. 2 is a diagram for explaining a production process for a sintered body, which is used for the present example, and illustrates an apparatus for forming a green compact. A forming mold 5 comprises: a hollow-cylinder-configured die 51; a solid-cylinder-configured core 52, which is allocated in the inner space of the die 51 coaxially therewith; a bottom member 53, which is positioned below the die 51 and core 52; and an upper punch 54, which is positioned above the die 51. The bottom member 53 is fixed to the bottom portions of the die 51 and core 52. The upper punch 54 is formed as a hollow cylindrical configuration, and is allocated at a position slidably in the axial directions (the up/down directions of the drawing) between the die 51 and the core 52. And, a cavity 50 is demarcated by the die 51, the core 52 and the bottom member 53. Note that, in accordance with this forming mold 5, it is possible to form a hollow-cylinder-shaped green compact by means of forming the outer peripheral surface by the die 51, the inner peripheral surface by the core 52, the lower end surface by the bottom member 53, and the upper end surface by the upper punch 54, respectively.

A green compact was formed using the aforementioned apparatus. First of all, an iron-based metallic powder (KIP300A made by KAWASAKI SEITETSU), and an additive, which comprised graphite and lithium stearate, were prepared. A raw-material powder 1′ was obtained by mixing these so as to make a proportion of graphite: 0.7% by mass; and lithium stearate; 1% by mass. Moreover, two copper-plate rings were made ready, copper-plate rings whose dimensions differed (outside diameter: φ96 mm; inside diameter: φ93 mm; and thickness: 3 mm; hereinafter labeled “copper-plate ring 31 for end surface”; and outside diameter: φ99.4 mm; inside diameter: φ94 mm; and thickness: 3 mm; hereinafter labeled “copper-plate ring 32 for side surface”).

And, a predetermined amount of the raw-material powder 1′ was filled into the lower portion of the cavity 50. After smoothing the surface of the filled raw-material powder 1′ so as to be the 10-mm position from the bottom member 53, the copper-plate ring 32 for side surface was placed on its surface. On this occasion, the outer peripheral surface of the copper-ring plate 32 for side surface was brought into contact with the inner wall surface of the cavity 50 (die 51), as shown in FIG. 2. On the raw-material powder 1′, which had been filled in advance, and on the copper-plate ring 32 for side surface, the raw-material powder 1′ was further filled. After smoothing the surface of the filled raw-material powder 1′ the copper-plate ring 31 for end surface was furthermore placed coaxially with the cavity 50. And, the raw-material powder 1′ was filled so as to be flush with one of the end surfaces of the copper-plate ring 31 for end surface. That is, the one of the end surfaces of the copper-plate ring 31 for end surface was brought into contact with the end surface of the upper punch 54, upon forming by pressurizing.

Thereafter, by descending the upper punch 54, the raw-material powder 1′, which was filled in the cavity 50, and the copper-plate rings 31, 32 were subjected to forming by pressurizing, and were thereby turned into a green compact 10′; and was then subjected to mold releasing to remove it from the cavity 50. The obtained green compact 10′ was such that the outside diameter was φ100 mm; the inside diameter was φ89 mm; the height was 60 mm; and the volumetric fraction was Vf=75[%].

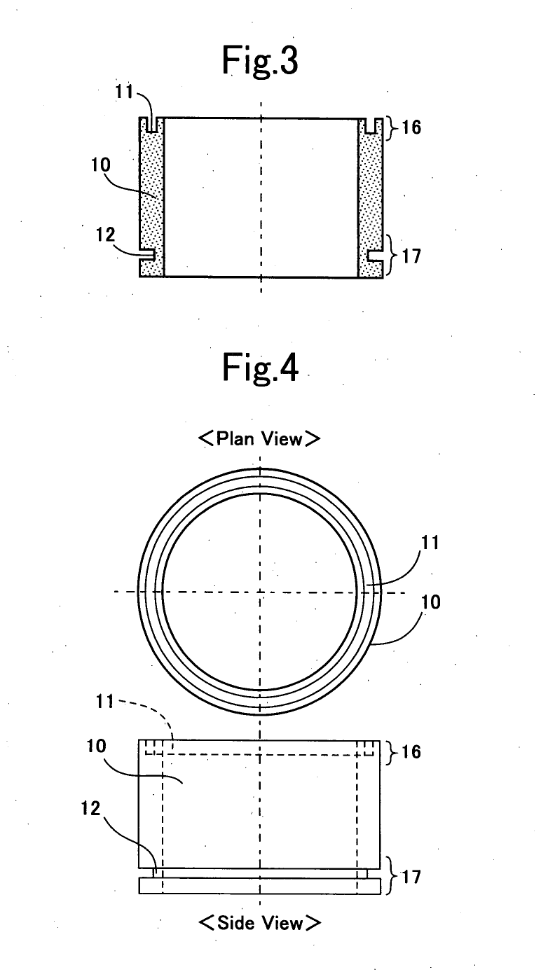

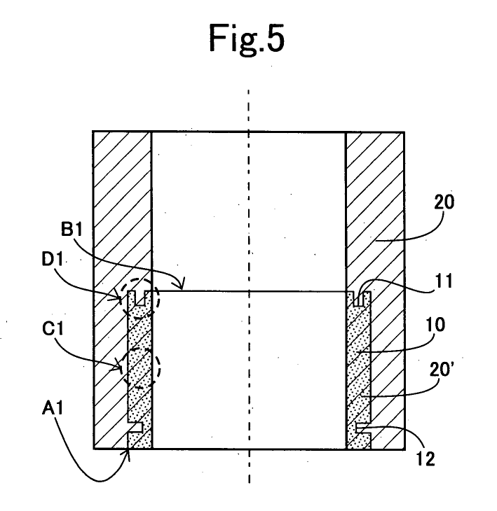

Next, the green compact 10′ was sintered at 1,150° C. for 1 hour in vacuum. FIG. 3 and FIG. 4 are diagrams for illustrating a sintered body 10, which was obtained by sintering the green compact 10′. The sintered body 10 was such that, since the copper-plate rings 31, 32 had been melted to disappear, cross-sectionally letter-U-shaped ring-shaped grooves (end-portion ring-shaped groove 11, and side-portion ring-shaped groove 12) were formed at the upper end portion and outer peripheral portion of the hollow-cylinder-shaped sintered body 10.

[Manufacture of Metallic Composite Member]

Using the sintered body 10 obtained in the aforementioned process, a hollow-cylindrical metallic composite material was manufactured. The sintered body 10 was allocated at a predetermined position in the cavity of a squeeze casting mold, and was preheated to 300° C. in an argon atmosphere. In such a state, an aluminum-alloy molten metal (ADC12, and 800-° C. molten-metal temperature) was poured into the cavity, and was pressurized with 100-MPa casting pressure. Thus, a metallic composite material, which possessed the aluminum alloy on the surface and the porous sections of the sintered body 10, was obtained. The axial cross-sectional diagram of the obtained metallic composite material is illustrated in FIG. 5. In the end-portion ring-shaped groove 11 and side-portion ring-shaped groove 12 of the sintered body 10, protruded portions, which were made of the aluminum alloy, were formed by means of casting, and the grooves and protruded portions fitted to each other. Moreover, at the locations designated with the end portion 16 and side portion 17 in FIG. 3 and FIG. 4, it was possible to visually observe the fact that copper was diffused in widths of 10-20 mm approximately over the entire circumference of the sintered body 10.

Note that the section, which was made of the aluminum alloy being formed on the surface of the sintered body 10 (being labeled aluminum alloy 20 in FIG. 5) alone, is referred to as a parent-material portion, and the section, which was made of the sintered body 10 and the aluminum alloy being infiltrated into the porous sections thereof and being solidified therein (being labeled aluminum alloy 20′ therein), is referred to as a composited portion. Of this interface between the parent-material portion and the composited portion, the interface, which was exposed in the surfaces of the composite material, could be observed linearly in the hollow-cylinder lower surface, which is designated with A1 in FIG. 5, and in the hollow-cylinder inner surface, which is designated with B1 in FIG. 5. The end-portion ring-shaped groove 11 and side-portion ring-shaped groove 12; and the protruded portions that fitted with these; the fitting portions, were formed along the planes, which involved these exposed sections.

Moreover, a metallic composite material was made ready as a comparative example, metallic composite material which was manufactured in the same manner as the example except that a sintered body, which did not possess any dented portion (which was manufactured without using the copper-plate rings during the sintering), was used.

[Evaluation]

[Existence and Nonexistence of Cracks]

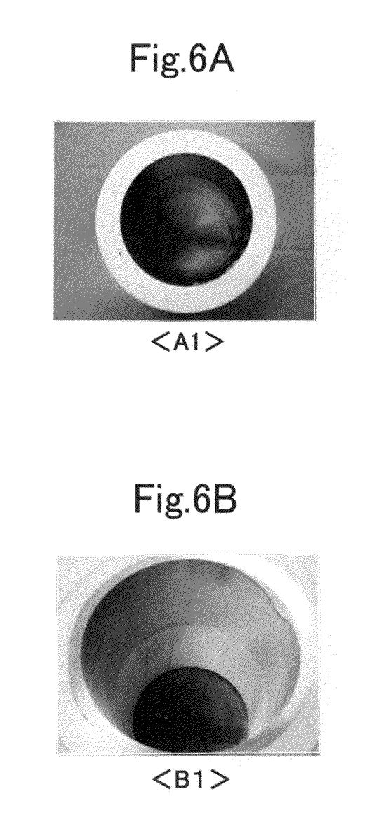

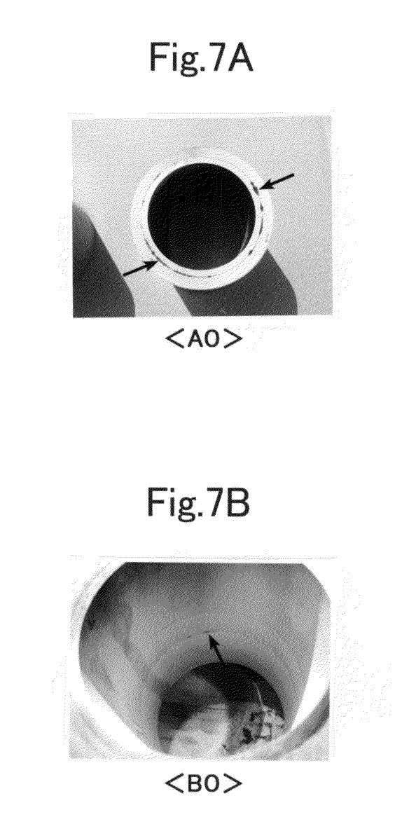

Regarding the metallic composite materials according to the example and comparative example, a thermal treatment (holding them at 500° C. for 10 hours and thereafter cooling them slowly) was carried out, and then they were inspected for whether cracks occurred or not in the metallic composite materials after the thermal treatment by means of liquid penetrant inspection (color checking inspection). The results are shown in FIG. 6A, FIG. 6B, FIG. 7A and FIG. 7B. Note that FIG. 6A <A1> is a photograph in which the lower end surface of the metallic composite material according to the example was photographed, and is equivalent to the position designated with A1 in FIG. 5. FIG. 6B <B1> is a photograph in which the inner surface of the metallic composite material according to the example was photographed, and is equivalent to the position designated with B1 in FIG. 5. Moreover, although FIG. 7A <A0> and FIG. 7B <B0> relate to the metallic composite material according to the comparative example, they are photographs in which parts, being equivalent to the positions designated with A1 and B1 in FIG. 5, are photographed.

In the metallic composite material according to the example, the occurrence of cracks was hardly appreciated. However, in the metallic composite material according to the comparative example in which no dented portion was formed, cracks occurred in a part of the inner surface and in the entire circumference of the lower end surface (see the arrowheaded sections in FIG. 7A and FIG. 7B). Namely, by means of the dented portions formed in the sintered body, the occurrence of cracks, which would have occurred in the outer peripheral surface and upper end surface of the sintered body, was suppressed.

Note that, in regard to the inner peripheral surface which is the blind spot in <B1> and <B0>, the situation was the same as described above.

[Cross-Sectional Surface Observation]

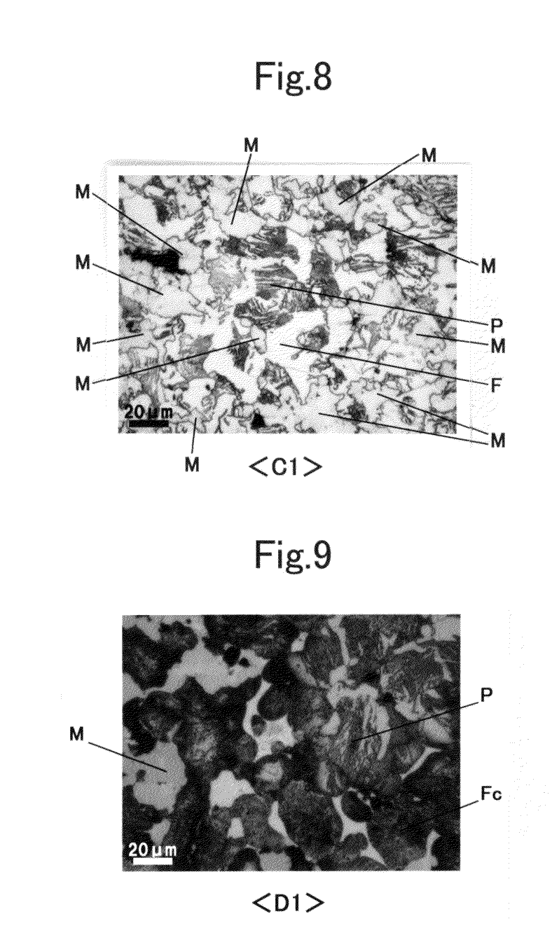

Regarding the metallic composite material according to the example, the cross-sectional structure was observed by means of a metallurgical microscope. The cross-sectional observation was carried out with respect to the composited portion of the metallic composite material, and the cut cross-section was observed after etching it with nital etchant (3% by weight) for 30 seconds. The results are shown in FIG. 8 and FIG. 9. Note that FIG. 8 is a photograph in which the cross-section of the composited portion, being surrounded with C1 designated in FIG. 5, was observed; and FIG. 9 is a photograph in which the cross-section of the composited portion, being surrounded with D1 designated in FIG. 5, was observed.

In FIG. 8 and FIG. 9, the sections, which were corroded lamellarly, are pearlite (being represented with P). In FIG. 8, the sections, whose color is pale, are ferrite (being represented with F), and the sections, whose color is deep, are the aluminum alloy (being represented with M). In FIG. 8, the sections, which are represented with M, occupy 25% of the entire cross section approximately. Moreover, in FIG. 9, the black sections (being represented with Fc) are sections in which copper solved into iron.

In the composited portion, which is positioned at C1, the sintered body 10, which was made by sintering the iron-based metallic powder, was such that most of it was ferrite; and turned into pearlite partially. And, the aluminum alloy was infiltrated into the porous sections of the sintered body 10, and was solidified therein. Moreover, in the composited portion, which is positioned at D1, most of it was pearlite, and copper solved into iron. And, sections in which the aluminum alloy was solidified in the porous sections of the sintered body 10 could be confirmed. Namely, in the sintered body 10, the copper-plate rings 31, 32 were diffused into iron so that they had melted to disappear during the sintering process, and consequently the pores were not clogged with copper.

[Vickers Hardness Measurement]

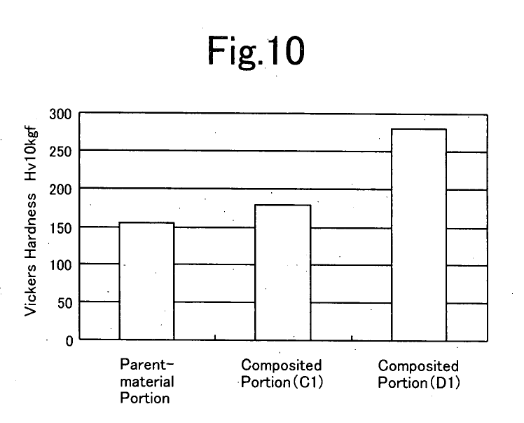

Regarding the metallic composite material according to the example, a Vickers hardness measurement was carried out. The Vickers hardness measurement was carried out, in the outer peripheral surface (parent-material portion) of the metallic composite material and in the composited portions C1 and D1 which were subjected to the cross-sectional observation, with a measuring load of 10 kgf using a Vickers hardness meter. The measured results are shown in FIG. 10.

The Vickers hardness of the composited portions was greater than the Vickers hardness of the parent-material portion (the section made of the aluminum alloy alone). Moreover, the composited portion (in which copper solved into the sintered body 10), which is positioned at D1, was such that the Vickers hardness was much greater than that of the composited portion, which is positioned at C1. Namely, the metallic composite material according to the present example is good in terms of the strength and wear resistance in the vicinity around the ring-shaped grooves 11, 12.

1. A metallic composite material being a metallic composite material, which comprises: a composited portion having a sintered body being completed by sintering a metallic powder of a first metal, and a second metal infiltrating into the pores of the superficial-layer portion of the sintered body at least; and a parent-material portion having the second metal covering the composited portion,
the metallic composite material being characterized in that: said sintered body is completed by sintering said metallic powder together with a melt-disappearing material, which possesses a melting point being the sintering temperature of the metallic powder or less, or a burn-disappearing material, which burns to disappear at the sintering temperature or less, and has a dented portion, which is formed when the melt-disappearing material has been melted to disappear or the burn-disappearing material has been burned to disappear and in which said pores open in a surface thereof; said parent-material portion comprises said second metal, and has a covering portion, which covers a superficial side of said sintered body, superficial side in which said dented portion opens, and a protruded portion, which is formed integrally on a surface of the covering portion by infiltrating said second metal into the pores of the sintered body and additionally getting the second metal into the dented portion and which protrudes toward the dented portion; and said protruded portion and said dented portion constitute a fitting portion, which is formed, of the interface between the composited portion and the parent-material portion, along an interface involving a section being exposed linearly in a surface of the metallic composite material; and said protruded portion and said dented portion fit to each other.

2. (canceled)

3. The metallic composite material set forth in claim 1, wherein said melt-disappearing material includes an alloying component element, which forms an alloy with a major component element of said metallic powder, and the alloy is formed at parts of said sintered body, parts where the melt-disappearing material has been melted to disappear.

4. The metallic composite material set forth in claim 3, wherein said major component element is iron, and said alloying component element is copper.

5. The metallic composite material set forth in claim 1, wherein said first metal is an iron-based metal, which includes iron, and said second metal is a light metal.

6. The metallic composite material set forth in claim 5, wherein said light metal is an aluminum alloy.

7. The metallic composite material set forth in claim 1, wherein said sintered body is a hollow cylindrical configuration, and has said dented portion at either one of an outer peripheral portion, inner peripheral portion, end portion and another end portion thereof at least.

8. The metallic composite material set forth in claim 7, wherein said dented portion is an annular ring-shaped groove, which is positioned coaxially with said sintered body being formed as a hollow cylindrical configuration.

9. The metallic composite material set forth in claim 8, wherein said ring-shaped groove is a cross-sectionally letter-U shape.

10. The metallic composite material set forth in claim 1, wherein said fitting portion is a groove-shaped dented portion, which is a part of said interface and is formed parallelly to a line being exposed in a surface thereof.

11. The metallic composite material set forth in claim 1, wherein a depth of said dented portion is 2.7-3 mm.

12. The metallic composite material set forth in claim 1, wherein said sintered body is a hollow cylindrical configuration, and at least its inner peripheral surface is exposed in a surface thereof.
